(19) United States
(12) Patent Application Publication
(10) Pub. No.: US 2006/0087503 A1
(43) Pub. Date: Apr. 27, 2006

(54) Electronic apparatus with display control function

(75) Inventors: Tomoki Sasaki, Takefu-city (JP); Masakazu Kobayashi, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/248,338

(22) Filed: Oct. 13, 2005

(30) Foreign Application Priority Data
Oct. 22, 2004 (JP) 2004-308546

(51) Int. Cl. G09G 5/00

(52) U.S. Cl. 345/211

(57) ABSTRACT

To provide a method of reducing power consumption of an electronic apparatus including a display unit, and an electronic apparatus with a display control function that set a predetermined time, execute a power-saving mode when the predetermined time has elapsed, and return to an original state automatically when the user simply performs a particular operation. An electronic apparatus with a display control function includes an operation instructing unit 4 that instructs an operation instructed by operating plural input keys 3 arranged on a remote control 2, an operation control unit 5 that controls an operation, a timer 6 that performs timer setting and measurement of time, a setting holding memory 7 that holds a setting for a power-saving mode, a screen display control unit 8 that controls the display screen 9, and the display screen 9 that performs blinking display.

The present application is based on and claims priority of Japanese patent application No. 2004-308546 filed on Oct. 22, 2004, the entire contents of which are hereby incorporated by reference.

### BACKGROUND OF THE INVENTION

1. Field of the Invention

The present invention relates to a method of reducing power consumption of an electronic apparatus including a display unit such as a display screen or a display tube. In particular, the invention relates to an electronic apparatus with a display control function that makes it possible to set a predetermined time until it is judged that a user is not looking at the display unit, execute a power-saving mode when the predetermined time has elapsed, and return to an original state easily when the user simply depresses any one of instruction input keys.

2. Description of the Related Art

Conventionally, as a method of reducing power consumption of an electronic apparatus including a display screen, for example, screen display of a cathode ray tube (CRT) is performed at low luminance when an operator is not present for a fixed time or more. As another method, the electronic apparatus includes a data input unit and, when data is not inputted to the data input unit for a predetermine time, changes luminance of the cathode ray tube. Alternatively, line connection of a cellular phone is monitored and, when a fixed time has elapsed from the line connection, display is turned off or luminance adjustment is performed.

Concerning such methods of reducing power consumption of an electronic apparatus, for example, as a conventional technique, Japanese Patent Laid-Open Publication No. 5-188869 discloses a method of, in a liquid crystal display panel with a backlight, performing control to reduce brightness of the backlight stepwise when there is no access for more than a predetermined time and return brightness to an initial state when there is an access and turning off a power supply for the backlight and the liquid crystal display panel considering that the liquid crystal panel is in an unused state when the number of times of repetition of the stepwise reduction in brightness has exceeded a predetermined number of times.

### SUMMARY OF THE INVENTION

In conventional techniques, examples of the display unit are as described below. In general homes, there are a plasma display panel in a large-size television, a CRT or a liquid crystal display panel in a television, a personal computer, and the like, a liquid crystal display panel in a subscriber telephone and a cellular phone, and a display tube used for applications such as a VCR device and a DVD device. When no operation is performed using input keys of a remote controller or an electronic apparatus body, power consumption is reduced by decreasing brightness of the display units stepwise. In this case, it is likely that, when the brightness is too low, a user considers that a power supply of an electronic apparatus is off and forgets to turn off the power supply. In the case of the cellular phone, a clock display is dim and hard to read when luminance of the display unit is decreased. It is necessary to increase luminance of the display unit by performing specific key operation to return the display unit to high luminance. It is an object of the invention to provide an electronic apparatus with a display control function that improves the method of reducing power consumption in the conventional techniques, prevents a user from forgetting to turn off a power supply, and makes it possible to save power consumed in operation for returning a power-saving mode to a normal state.

An electronic apparatus with a display control function according to a first aspect of the invention includes: an instruction input unit that inputs an instruction according to operation of plural input keys; an operation instructing unit that instructs an operation on the basis of the instruction inputted; an operation control unit that receives an instruction from the operation instructing unit and controls an operation; a timer that is controlled by the operation control unit to perform timer setting; a setting holding memory that is controlled by the operation control unit to hold a setting; a display control unit that is controlled by the operation control unit to control a display unit; and a display unit that is controlled by the display control unit to display information. In the electronic apparatus, the timer measures elapsed times for a no-operation time, which is a standby time during which none of the input keys is operated, until a power-saving mode is executed, an OFF time during which the display unit is off, and an ON time during which the display unit is on. The setting holding memory holds time setting data for each of the no-operation time, the OFF time, and the ON time. The display control unit controls the display unit to blink. Consequently, the electronic apparatus executes, when the no-operation time, during which operation of the instruction input unit is not performed, exceeds a predetermined time, a blinking power-saving mode in which the display unit repeats light-on and light-off at a predetermined interval.

According to the constitution in the first aspect of the invention, the electronic apparatus with a display control function includes: an instruction input unit that inputs an instruction according to operation of plural input keys; an operation instructing unit that instructs an operation on the basis of the instruction inputted; an operation control unit that receives an instruction from the operation instructing unit and controls an operation; a timer that is controlled by the operation control unit to perform timer setting; a setting holding memory that is controlled by the operation control unit to hold a setting; a display control unit that is controlled by the operation control unit to control a display unit; and a display unit that is controlled by the display control unit to display information. In the electronic apparatus, the timer measures elapsed times for a no-operation time, which is standby time during which none of the input keys is operated, until a power-saving mode is executed, an OFF time during which the display unit is off, and an ON time during which the display unit is on. The setting holding memory holds time setting data for each of the no-operation time, the OFF time, and the ON time. The display control unit controls the display unit to blink. Consequently, the electronic apparatus executes, when the no-operation time, during which operation of the instruction input unit is not performed, exceeds a predetermined time, a blinking power-saving mode in which, the display unit repeats light-on and light-off at a predetermined interval. Thus, when there is no operation by input keys of a remote controller or an electronic apparatus body for a predetermined time, the electronic apparatus can repeat light-off and light-on with usual brightness at a predetermined interval.

According to a second aspect of the invention, in the electronic apparatus with a display control function according to the first aspect of the invention, it is possible to set the no-operation time, the OFF time, and the ON time according to operation of the input keys.

According to the constitution in the second aspect of the invention, it is possible to set the no-operation time, the OFF time, and the ON time according to operation of the input keys. Thus, a user can perform time setting as the user desires according to a situation.

According to a third aspect of the invention, in the electronic apparatus with a display control function according to the second aspect of the invention, the electronic apparatus executes, when operation of the instruction input unit is not performed for a predetermined time, a luminance-changing power-saving mode in which low-luminance display for decreasing luminance of the display unit to predetermined luminance and high-luminance display with usual luminance are repeated at the predetermined interval.

According to the constitution in the third aspect of the invention, the electronic apparatus executes, when operation of the instruction input unit is not performed for a predetermined time, a luminance-changing power-saving mode in which low-luminance display for decreasing luminance of the display unit to predetermined luminance and high-luminance display with usual luminance are repeated at the predetermined interval. Thus, the electronic apparatus can repeat usual brightness and low brightness alternately at a predetermined interval when it is inconvenient to turn off the display unit completely.

According to a fourth aspect of the invention, in the electronic apparatus with a display control function according to the second or the third aspect of the invention, when any one of the plural input keys is depressed and when the electronic apparatus performs a specific operation during execution of the blinking power-saving mode or the luminance-changing power-saving mode, the electronic apparatus cancels the repetition operations and returns to an original state and does not execute the blinking power-saving mode or the luminance-changing power-saving mode until the time when operation of the instruction input unit is not performed even if the predetermined time elapses again.

According to the constitution in the fourth aspect of the invention, when any one of the plural input keys is depressed and when the electronic apparatus performs a specific operation during execution of the blinking power-saving mode or the luminance-changing power-saving mode, the electronic apparatus cancels the repetition operations and returns to an original state and does not execute the blinking power-saving mode or the luminance-changing power-saving mode until the time when operation of the instruction input unit is not performed even if the predetermined time elapses again. Thus, the electronic apparatus can easily returned to an original state from the power-saving mode of the invention when a user simply depresses any one of the input keys of the electronic apparatus at random.

### BRIEF DESCRIPTION OF THE DRAWINGS

FIG. 1 is a block diagram for explaining a schematic constitution for controlling blinking power-saving mode display of a television in a first embodiment of the invention;

FIG. 2 is a diagram for explaining an example of display on a setting menu screen for the blinking power-saving mode in the first embodiment;

FIGS. 3A to 3C are diagrams for explaining an example of display on a display screen for the blinking power-saving mode in the first embodiment;

FIG. 4 is a flowchart showing an operation flow of the blinking power-saving mode in the first embodiment;

FIG. 5 is a block diagram for explaining a schematic constitution for controlling blinking power-saving mode display of a DVD device in a second embodiment of the invention;

FIG. 6 is a diagram for explaining a remote controller that sets and instructs the blinking power-saving mode in the second embodiment;

FIGS. 7A to 7C are diagrams for explaining an example of display on a display tube in the blinking power-saving mode in the second embodiment;

FIG. 8 is a flowchart showing an operation flow of the blinking power-saving mode in the second embodiment;

FIG. 9 is a block diagram for explaining a schematic constitution for controlling power-saving mode display of a cellular phone in a third embodiment of the invention;

FIG. 10 is a diagram for explaining a setting menu screen for aluminance-changing power-saving mode in the third embodiment;

FIGS. 11A and 11B are diagrams for explaining an example of a selection menu screen for selecting the blinking power-saving mode and the luminance-changing power-saving mode and an example of a setting menu screen for the luminance-changing power-saving mode in the third embodiment;

FIGS. 12A to 12C are diagrams for explaining an example of a display screen for the luminance-changing power-saving mode in the third embodiment; and

FIG. 13 is a flowchart showing an operation flow in the luminance-changing power-saving mode in the third embodiment.

### DETAILED DESCRIPTION OF THE PREFERRED EMBODIMENTS

The invention provides an electronic apparatus that improves a method of reducing power consumption in a display unit, prevents a user from forgetting to turn off a power supply, and makes it possible to save power consumed by operation for returning the electronic apparatus from a power-saving mode to a normal state. In the following explanation of embodiments, only one form in embodying the invention is explained. However, the explanation does not intend to limit the invention within a range of the explanation.

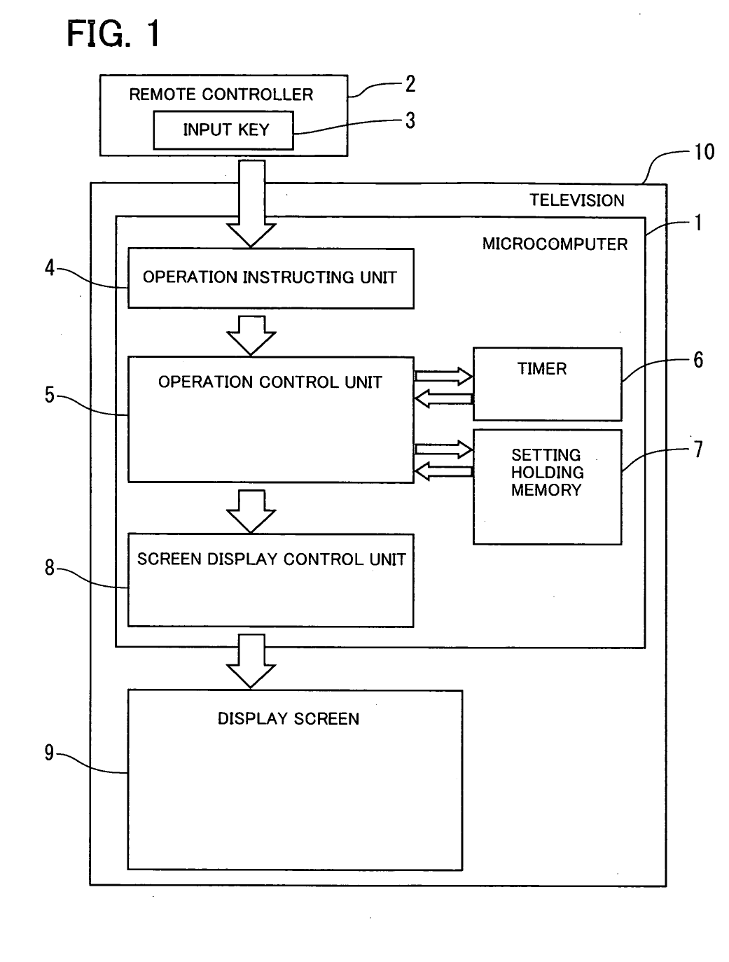

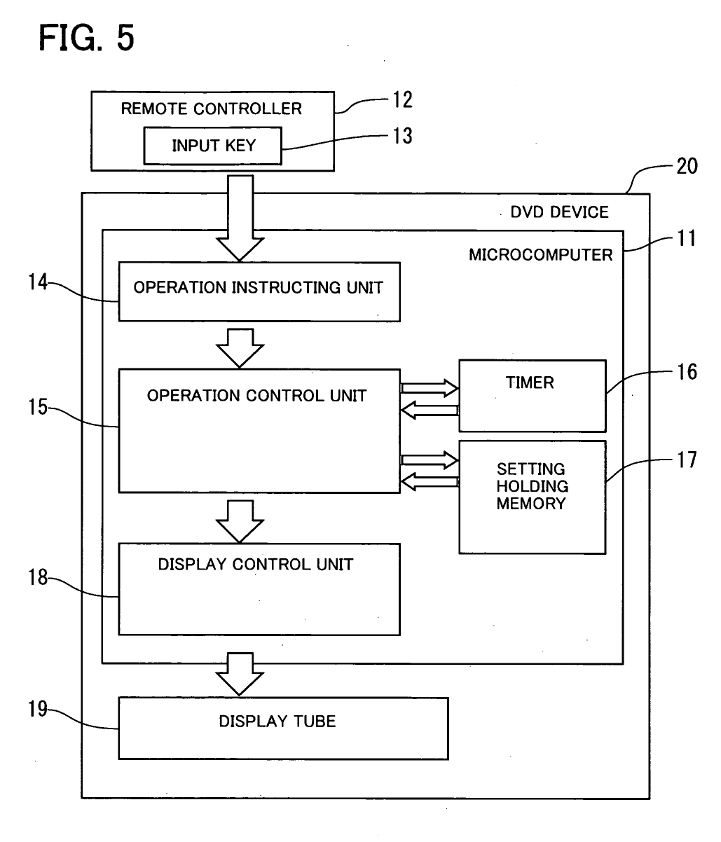

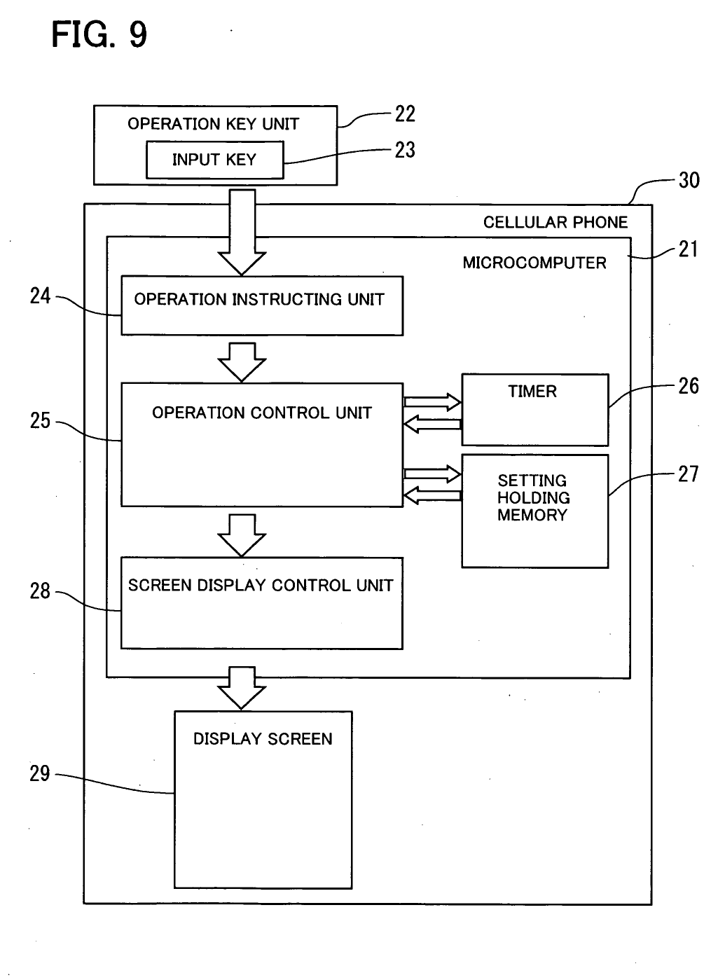

Embodiments of the invention will be hereinafter explained with reference to FIGS. 1 to 13. FIGS. 1 to 4 are diagram for explaining a display screen of a television having a blinking power-saving mode in a first embodiment. FIGS. 5 to 8 are diagrams for explaining a display tube of a DVD device having a blinking power-saving mode in a second embodiment. FIGS. 9 to 13 are diagrams for explaining a display screen of a cellular phone having a luminance-changing power-saving mode in a third embodiment. It goes without saying that the invention is also readily applicable to electronic apparatuses other than those explained in the embodiments without departing from the spirit of the invention.

### First Embodiment

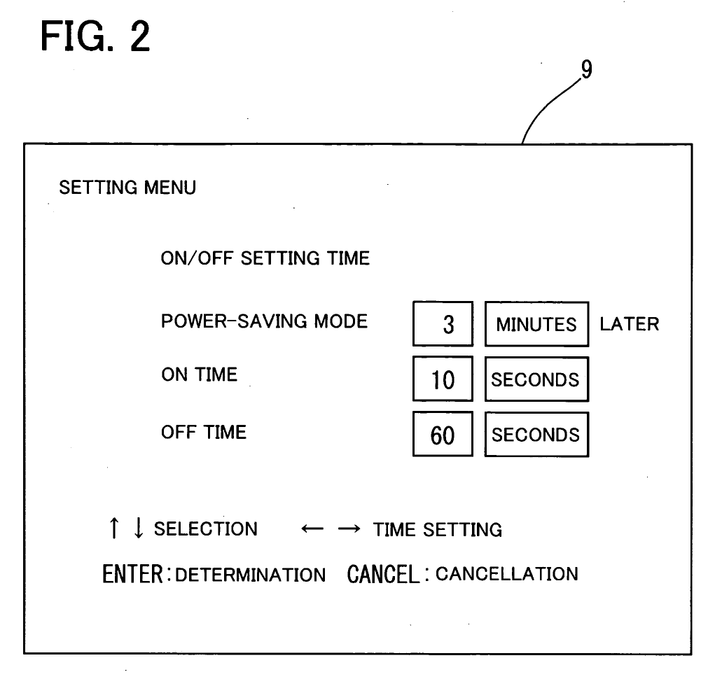

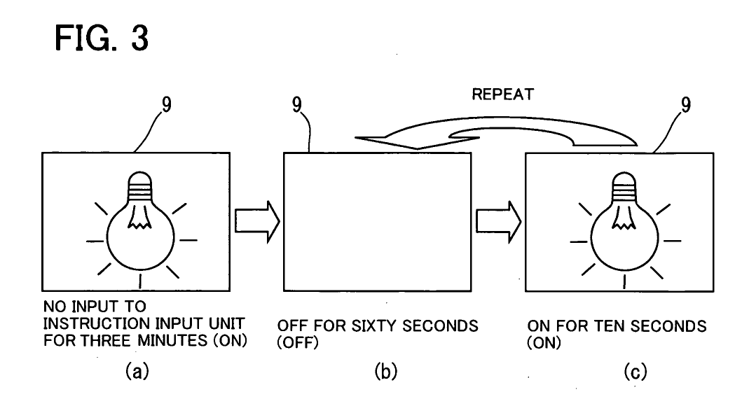

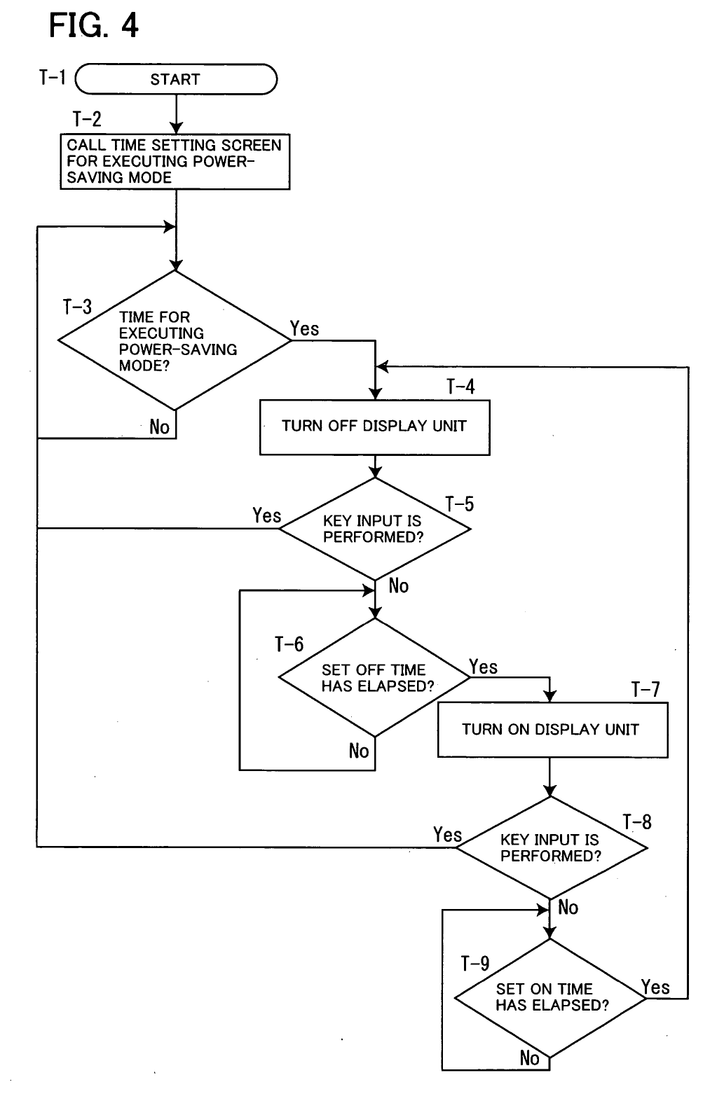

FIGS. 1 to 4 are diagrams for explaining a television having a blinking power-saving mode in the first embodiment. FIG. 1 is a block diagram for explaining a display control function in the television. FIG. 2 is a diagram for explaining an example of display on a menu screen for setting a power-saving mode. FIGS. 3A to 3C are diagrams for explaining an example of display on a display screen according to the blinking power-saving mode. FIG. 4 is a flowchart for explaining an operation for executing the blinking power-saving mode.

A television 10 shown in FIG. 1 includes a remote controller 2 that inputs an instruction according to operation of plural input keys 3, a microcomputer 1 that controls execution of a power-saving mode on the basis of the instruction inputted, and a display screen 9 that is controlled by the microcomputer 1 to execute power-saving mode display. The microcomputer 1 includes an operation instructing unit 4 that receives an instruction from the remote controller 2 and instructs an operation, an operation control unit 5 that receives an instruction from the operation instructing unit 4 and controls an operation, a timer 6 that is controlled by the operation control unit 5 to perform timer setting, a setting holding memory 7 that is controlled by the operation control unit 5 to hold a setting for the power-saving mode, and a screen display control unit 8 that is controlled by the operation control unit 5 to control the display screen 9. The display screen 9 is a CRT, a liquid crystal display panel, a plasma display panel, or the like that is controlled by the screen display control unit 8 to display information. In the television 10, in executing the blinking power-saving mode, the timer 6 measures elapsed times for a no-operation time, which is a standby time during which none of the input keys 3 of the remote controller 2 is operated by a user, until a power-saving mode is executed, an OFF time during which the display screen 9 is off, and an ON time during which the display screen 9 is on. The setting holding memory 7 holds time setting data for each of the no-operation time, the OFF time, and the ON time. The screen display control unit 8 controls the display screen 9 to blink. Consequently, when the no-operation time, during which operation of the remote controller 2 is not performed, exceeds a predetermined time, the display screen 9 can repeat light-on and light-off at a predetermined interval.

Subsequently, a method of setting the blinking power-saving mode while looking at a setting menu displayed on the display screen will be explained with reference to FIGS. 1 to 2. To set the blinking power-saving mode according to the invention, the user operates any one of the input keys 3 of the remote controller 2 shown in FIG. 1 to transmit an instruction signal for displaying a setting menu screen. Then, a not-shown remote control light-receiving unit arranged in the television 10 receives the instruction signal and transmits the instruction signal to the operation instructing unit 4. The operation instructing unit 4 instructs the operation control unit 5 to perform control to extract setting menu screen information from the setting holding memory 7. The setting holding memory 7 transmits the setting menu screen information stored and held there into the operation control unit 5. The operation control unit 5 transmits the setting menu screen information to the screen display control unit 8 and controls the screen display control unit 8 to display the setting menu screen information on the display screen 9. The screen display control unit 8 controls the display screen 9 to display the setting menu screen information thereon to thereby display a setting menu shown in FIG. 2 on the display screen 9.

In the setting menu shown in FIG. 2 displayed on the display screen 9, spaces for showing setting times are provided. When a standby time until the power-saving mode is executed, an OFF time during which the display screen 9 is off, and an ON time during which the display screen 9 is on are inputted as numerical values with a ten key of the remote controller 2 and units of respective setting times such as hour, minute, and second are selected and inputted, the inputted setting times are displayed in the spaces. On a lower side of the display screen 9, arrows indicating upward and downward directions are displayed. It is possible to operate the input keys 3 of the remote controller 2 to move a cursor on a not-shown screen and select the spaces of the power-saving mode, the OFF time, and the ON time using the arrows. It is also possible to easily select the units of the setting times. In addition, arrows indicating left and right directions are also displayed. The arrows are displayed such that it is possible to easily select the spaces for the setting times and the spaces for the units of the setting times and set numerical values and the units in the spaces with the remote controller 2. Below the arrows, “Enter: determination” and “CANCEL: cancellation” are displayed to make it possible to determine and cancel the setting times by depressing not-shown Enter key and Cancel key in the input keys 3 of the remote controller.

The user operates the input keys 3 of the remote controller 2 to set setting times in order from an execution standby time for the power-saving mode in accordance with display of the setting menu. When the user operates the input keys 3 of the remote controller 2 to input “3” and “minute”, the operation instructing unit 4 instructs the operation control unit 5 to cause the setting holding memory 7 to store and hold the execution standby time for the power-saving mode as “3 minutes” later. Subsequently, in the same manner, the operation instructing unit 4 sets the OFF time as “60” “seconds” and the ON time as “10” “seconds” and causes the setting holding memory 7 to store and hold the setting times. When the setting ends, the user can depress the not-shown Enter key of the remote controller 2 and determine the setting in accordance with screen display. If it is necessary to correct the time set, when the correction is performed before the user depresses the not-shown Enter key to determine the time, for example, in order to correct the OFF time to 30 seconds, the user can move the not-shown cursor to the space of the OFF time in accordance with the up and down arrows, depress the not-shown Cancel key to erase the numerical value displayed, and rewrite the OFF time as “30” seconds. If the correction is performed after the user depressed the not-shown Enter key to determine the time, since the screen display of the setting menu has already disappeared, the user can display the setting menu screen and, then, for example, in order to change the ON time to 20 seconds, move the not-shown cursor to the space of the ON time in accordance with the up and down arrows, depress the not-shown Cancel key to erase the numerical values displayed, and rewrite the ON time as “20” seconds.

The blinking power-saving mode and an example of screen display in the blinking power-saving mode will be explained with reference to FIGS. 3A to 3C. The blinking power-saving mode in the television 10 is a function for detecting a state in which, although a television program continues to be broadcasted, none of the input keys 3 arranged on the remote controller 2 shown in FIG. 1 is operated for a while because, for example, a user is away from the television 10 or falls into a doze and reducing power consumed by the display screen 9 of the television 10, on which a program is broadcasted, by turning on and off of the display screen 9 at a predetermined interval. FIG. 3A shows a state in which the remote controller 2 shown in FIG. 1 has already been operated to instruct an execution operation for the blinking power-saving mode and none of the input keys 3 of the remote controller 2 is operated for a while. It can be said that this is a no-operation time of the remote controller 2. This time is included in the standby time until the power-saving mode is executed and indicates a stage at which three minutes of the standby time until the power-saving mode set in FIG. 2 are about to pass. However, a program continues to be displayed on the display screen 9 of the television 10 brightly. FIG. 3B shows a state in which the standby time for three minutes has elapsed, time is in a light-off time frame for sixty seconds at the OFF time set in FIG. 2, the display screen 9 of the television 10 is turned off and dim, and no program is broadcasted. FIG. 3C shows a state in which sixty seconds of the OFF time has elapsed and time is in ten seconds of the ON time set in FIG. 2, which is a light-on time frame in which a program is broadcasted brightly on the display screen 9 as at the time of in FIG. 3A. When ten seconds of the ON time elapse, the operations at the OFF time during which the display screen 9 is off for sixty seconds and the ON time during which the display screen 9 is on for ten seconds are repeated until the user notices blinking of the television screen and operates any one of the input keys 3 of the remote controller 2.

An operation in the blinking power-saving mode in the television will be explained with reference to FIG. 4. In step T-1, the blinking power-saving mode is about to be started. In step T-2, a user operates the remote controller 2 shown in FIG. 1 to display the time setting screen for executing the power-saving mode on the display screen 9. The user depresses the not-shown Enter key to instruct execution of the power-saving mode. If setting for executing the blinking power-saving mode has not been performed, the user sets the standby time, the OFF time, and the ON time of the blinking power-saving mode on the basis of the setting menus explained with reference to FIG. 2. Step T-3 and subsequent steps indicate a stage in which the television 10 executes an operation according to the setting conditions for the blinking power-saving mode set. In step T-3, the timer 6 shown in FIG. 1 watches whether three minutes, the standby time until execution of the blinking power-saving mode set in FIG. 2, have elapsed. If it is not the time for executing the blinking power-saving mode, the timer 6 judges that three minutes have not elapsed (“NO” in step T-3) and continues to watch time in step T-3. When three minutes have elapsed, the timer 6 judges that three minutes have elapsed (“YES” in step T-3). In step T-4, the display screen 9 is turned off for sixty seconds set in FIG. 2. Thereafter, in step T-5, the television 10 checks whether the user has depressed any one of the input keys 3 of the remote controller 2 while the display screen 9 is off. When any one of the input keys 3 is depressed, the television 10 judged that any one of the input keys 3 is depressed (“YES” in step T-5) and returns to step T-3. The timer 6 shown in FIG. 1 starts measurement of time until the blinking power-saving mode is executed in the no-operation time of the remote controller 2. At this point, if none of the input keys 3 is depressed, the timer 6 judges that three minutes have not elapsed (“NO” in step T-3).

An operation for detecting depression of any one of the input keys 3 to cancel the blinking power-saving mode will be explained. When the user depresses any one of the input keys 3, the operation instructing unit 4 informs the operation control unit 5 that the input key 3 is depressed. If switching of a channel or silencing is instructed through the depression of the input key 3, the operation control unit 5 informs a not-shown video/sound control unit of the television 10 of a content of the instruction. In addition, the operation control unit 5 controls the screen display control unit 8 and the timer 6 to cancel the blinking power-saving mode. According to the cancellation of the blinking power-saving mode, the timer 6 starts measurement of time until the blinking power-saving mode is executed again.

In the case of “NO” in step T-5, the display screen 9 is still off at the OFF time. In step T-6, the timer 6 continues to measure the OFF time, which is the light-off time. When the OFF time has not elapsed (“NO” in step T-6), the timer 6 repeats the measurement until sixty seconds elapse. When sixty seconds have elapsed and the timer 6 judges in step T-6 that the OFF time has elapsed (“YES” in step T-6), in step T-7, the television 10 turns on the display screen 9 and keeps the display screen 9 on for ten seconds. After the display screen 9 is turned on, in step T-8, the television 10 checks whether the user has depressed any one of the input keys 3 of the remote controller 2 while the display screen 9 is on. When any one of the input key 3 is depressed, the television 10 judges that the input key 3 is depressed (“YES” in step T-6) and returns to T-3. The timer 6 shown in FIG. 1 starts measurement of time until the blinking power-saving mode is executed in the no-operation time of the remote controller 2. At this point, if none of the input keys 3 is depressed, the timer 6 judges that three minutes have not elapsed (“NO” in step T-3). In step T-9, the timer 6 continues to measure the set ON time, that is, the light-on time, of ten seconds. When the ON time of tens seconds has elapsed, the timer 6 judges that the ON time has elapsed (“YES” in step T-9) and returns to step T-4. The display screen 9 is turned off. After that, light-on and light-off of the display screen 9 is repeated continuously until the user depresses any one of the input keys 3 of the remote controller 2. Even if any one of the input keys 3 is depressed and the television 10 returns to an original state, if the no-operation time continues after that, the television 10 continues the operations in steps T-3 to T-9.

As described above, in the blinking power-saving mode in the display screen 9 such as a CRT, a liquid crystal display panel, or a plasma display panel of the television 10, the display screen 9 is kept completely off in the light-off time designated by the user. Thus, the television 10, which executes the blinking power-saving mode, can reduce power consumption. In executing the blinking power-saving mode, it is possible to perform setting with simple operation of a remote controller on the basis of the setting menu screen displayed on the display screen 9 of the television 10. Thus, it is possible to prevent operators from being limited even in general homes. Moreover, during execution of the blinking power-saving mode, the display screen 9 repeats blinking on the basis of a blinking interval of a predetermined time set by the user. The television 10 can automatically return to a program broadcast state of original brightness when the user, who notices the blinking of the display screen 9, simply depresses any one of the input keys 3. Thus, the television 10 can return to the program broadcast state even if the user does not depress the specific input key 3 such as a not-shown cancellation key of the remote controller for canceling the power-saving mode to return the television 10 to the original state from the power-saving mode. Anybody can return the television 10 to the original state easily when he/she finds the state in which the power-saving mode is executed. The display screen 9 repeats light-off and light-on at a predetermined interval. Since the display screen 9 displays information with original brightness at the time of light-on, the user can understand that the television 10 is executing the power-saving mode and what kind of program is broadcasted presently when the display screen 9 displays information brightly. In addition, it is possible to solve the problem in that the user misunderstands that the power supply is off and forgets to turn off the power supply. Even if any one of the input keys 3 is depressed and the television 10 returns to the original state, it is possible to continue the operations in steps T-3 to T-9 if the no-operation time continues after that.

### Second Embodiment

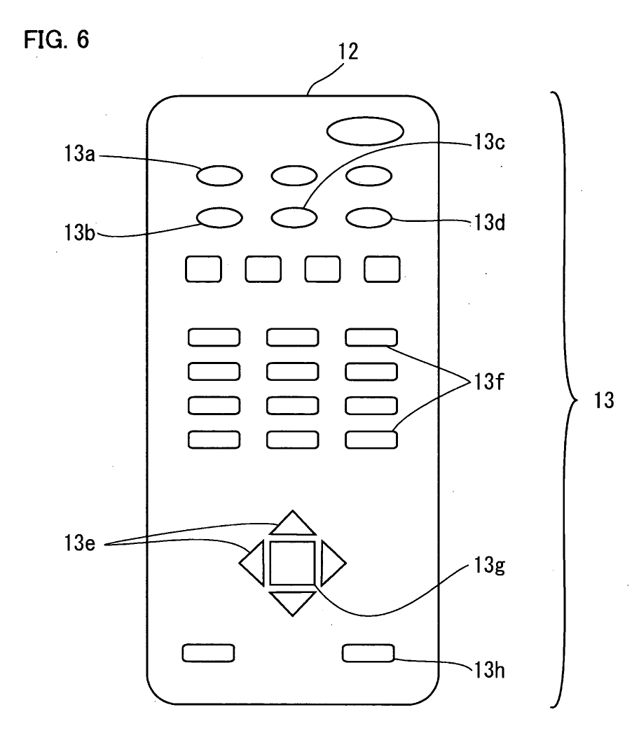

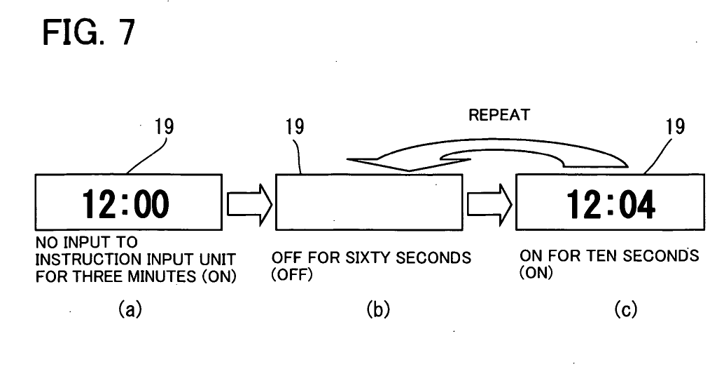

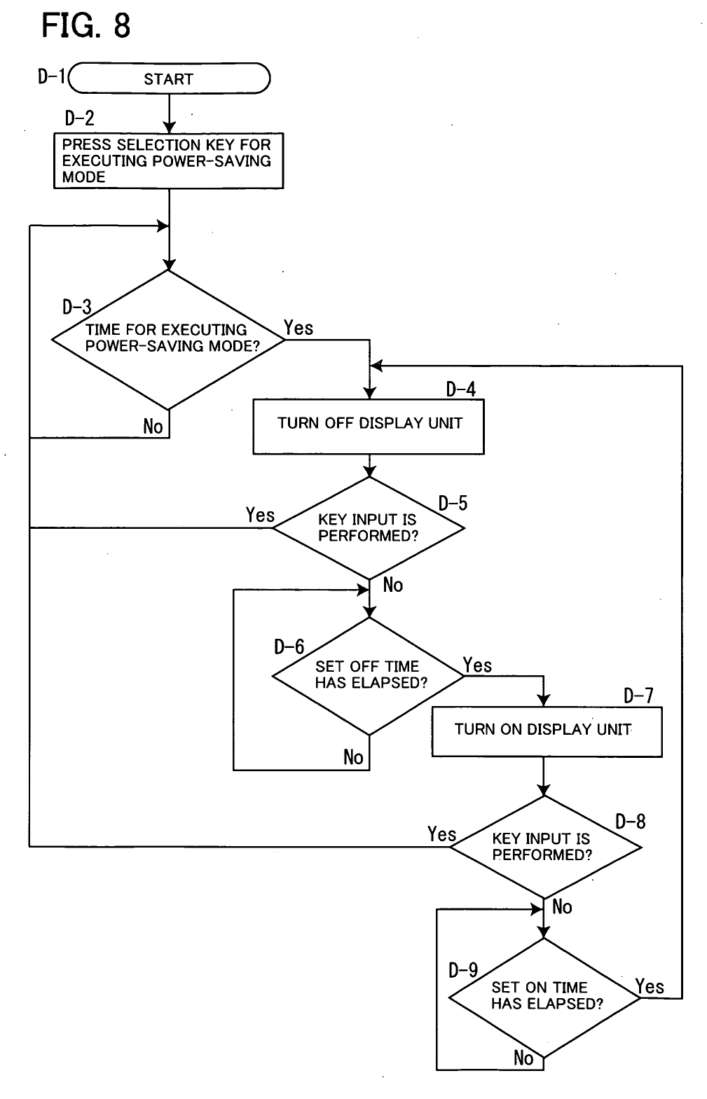

A second embodiment of the invention will be explained with reference to FIGS. 5 to 8. The second embodiment is a DVD device that includes a display tube having the blinking power-saving mode. FIG. 5 is a block diagram for explaining a display control method for the display tube in the DVD device. FIG. 6 is a diagram for explaining a remote controller that instructs setting and execution of the blinking power-saving mode. FIGS. 7A to 7C are diagrams for explaining an example of display on the display tube according to the blinking power-saving mode. FIG. 8 is a flowchart for explaining an operation for the blinking power-saving mode.

A DVD device 20 shown in FIG. 5 includes a remote controller 12 that inputs an instruction according to operation of plural input keys 13, a microcomputer 11 that controls execution of a power-saving mode on the basis of the instruction inputted, and a display tube 19 that is controlled by the microcomputer 11 to execute power-saving mode display. The microcomputer 11 includes an operation instructing unit 14 that receives an instruction from the remote controller 12 and instructs an operation, an operation control unit 15 that receives an instruction from the operation instructing unit 14 and controls an operation, a timer 16 that is controlled by the operation control unit 15 to perform timer setting, a setting holding memory 17 that is controlled by the operation control unit 15 to hold a setting for the power-saving mode, and a display control unit 18 that is controlled by the operation control unit 15 to control the display tube 19. The display tube 19 is controlled by the display control unit 18 to display information. In the DVD device 20, in executing the blinking power-saving mode, the timer 16 measures elapsed times for a no-operation time, which is a standby time during which none of the input keys 13 of the remote controller 12 is operated by a user, until a power-saving mode is executed, an OFF time during which the display tube 19 is off, and an ON time during which the display tube 19 is on. The setting holding memory 17 holds time setting data for each of the no-operation time, the OFF time, and the ON time. The screen display control unit 18 controls the display tube 19 to blink. Consequently, when the no-operation time, during which operation of the remote controller 12 is not performed, exceeds a predetermined time, the display tube 19 can repeat light-off and light-on at a predetermined interval.

A method of operating the input keys 13 of the remote controller 12 to set the blinking power-saving mode will be explained with reference to FIG. 6. A power-saving mode selecting key 13a, a standby time selecting key 13b, an OFF time selecting key 13c, an ON time selecting key 13d, a ten key 13f for inputting times as numerical values, a time unit selecting key 13e for selecting a unit of setting time, an Enter key 13g for determining an inputted numerical value and a unit of time, and a Cancel key 13h for canceling an inputted numerical value are arranged on the remote controller 12. A user depresses the power-saving mode selecting key 13a to select a power-saving mode and depresses the standby time selecting key 13b to make it possible to input a standby time. The user operates the time unit selecting key 13e to select in which position of hour, minute, and second a numerical value should be inputted while looking at “00:00:00” displayed on the display tube 19. Since the user wishes to set the standby time to three minutes, the user places a cursor on a position of “minute” substantially in the center of the display tube 19. Subsequently, the user depresses the ten key 13f to input the standby time as “03”, whereby the standby time is displayed as “00:03:00”. Subsequently, after depressing the OFF time selecting key 13c, the user places the cursor on a position of “second” with the time unit setting key 13e and depresses the ten key 13f to set the OFF time as 60 seconds. After depressing the ON time selecting key 13d, the user places the cursor on the position of “second” with the time unit selecting key 13e and depresses the ten key 13f to input the ON time as 10 seconds. If there is no problem in the time numerical values inputted, the user depressed the Enter key 13g to complete the setting. When the user changes the set time numerical values while the user depresses the ten key 13f, the user can cancel the inputted numerical values by depressing the Cancel key 13h and re-input numerical values to change the set time numerical values.

An example of display at the time when the blinking power-saving mode is executed on a display tube arranged on a DVD device will be explained with reference to FIGS. 7A to 7C. The display tube 19 arranged on the DVD device 20 shown in FIG. 5 usually indicates a present time as shown in FIG. 7A. The blinking power-saving mode in the DVD device 20 is a function for detecting a state in which none of the input keys 13 arranged on the remote controller 12 shown in FIG. 6 is not operated for a while because, for example, a user is away from the DVD device 20 and reducing power consumed by the display tube 19 by turning on and off the display of the present time at a predetermined interval. FIG. 7A shows a state in which the remote controller 12 shown in FIG. 6 has already been operated to instruct an execution operation for the blinking power-saving mode and none of the input keys 13 of the remote controller 12 is operated for a while. It can be said that this is a no-operation time of the remote controller 12. This time is included in the standby time until the power-saving mode is executed and indicates a stage at which three minutes of the standby time until the power-saving mode set in FIG. 6 are about to pass. However, the present time continues to be displayed on the display tube 19 of the DVD device 20 brightly. FIG. 7B shows a state in which the standby time for three minutes has elapsed, time is in a light-off time frame for sixty seconds at the OFF time set in FIG. 6, the display tube 19 of the DVD device 20 is turned off and dim and displays nothing. FIG. 7C shows a state in which sixty seconds of the OFF time has elapsed and time is in ten seconds of the ON time set in FIG. 6, which is a light-on time frame in which time is displayed brightly on the display tube 19 as at the time of in FIG. 7A. When ten seconds of the ON time have elapsed, the operations at the OFF time during which the display tube 19 is off for sixty seconds and the ON time during which the display tube 19 is on for ten seconds are repeated until the user notices blinking of the display tube 19 of the DVD device 20 and operates any one of the input keys 13 of the remote controller 12.

An operation in the blinking power-saving mode in the DVD device will be explained with reference to FIG. 8. In step D-1, the blinking power-saving mode has already been set and is about to be started. In step D-2, a user depresses the power-saving mode selecting key 13b shown in FIG. 6 to start execution of the blinking power-saving mode. In step D-3, the timer 16 shown in FIG. 5 watches whether three minutes, the standby time until execution of the blinking power-saving mode set in FIG. 6, have elapsed. If it is not the time for executing the blinking power-saving mode, the timer 16 judges that three minutes have not elapsed (“NO” in step D-3) and continues to watch time in step D-3. When three minutes have elapsed, the timer 16 judges that three minutes have elapsed (“YES” in step D-3) . In step D-4, the display tube 19 is kept off for sixty seconds set in FIG. 6. Thereafter, in step D-5, the DVD device 20 checks whether the user has depressed any one of the input keys 13 of the remote controller 12 while the display tube 19 is off. When any one of the input keys 13 is depressed, the DVD device 20 judges that any one of the input keys 13 is depressed (“YES” in step D-5) and returns to step D-3. The timer 16 shown in FIG. 5 starts measurement of time until the blinking power-saving mode is executed in the no-operation time of the remote controller 12. At this point, if none of the input keys 3 is depressed, the timer 16 judges that three minutes have not elapsed (“NO” in step D-3) . In the case of “NO” in step D-5, the display tube 19 is still off at the OFF time. In step D-6, the timer 16 continues to measure the OFF time, which is the light-off time. When the OFF time has not elapsed (“NO” in step D-6), the timer 16 repeats the measurement until sixty seconds elapse. When sixty seconds have elapsed and the timer 16 judges in step D-6 that the OFF time has elapsed (“YES” in step D-6), in step D-7, the DVD device 20 turns on the display tube 19 and keeps the display tube 19 on for ten seconds. After the display tube 19 is turned on, in step D-8, the DVD device 20 checks whether the user has depressed any one of the input keys 13 of the remote controller 12 while the display tube 19 is on. When any one of the input key 13 is depressed, the DVD device 20 judges that the input key 13 is depressed (“YES” in step D-6) and returns to D-3. The timer 16 shown in FIG. 5 starts measurement of time until the blinking power-saving mode is executed in the no-operation time of the remote controller 12. At this point, if none of the input keys 13 is depressed, the timer 16 judges that three minutes have not elapsed (“NO” in step D-3). In step D-9, the timer 16 continues to measure the set ON time, that is, the light-on time, of ten seconds. When the ON time of tens seconds has elapsed, the timer 16 judges that the ON time has elapsed (“YES” in step D-9) and returns to step D-4. The display tube 19 is turned off. After that, light-on and light-off of the display tube 19 are repeated continuously until the user depresses any one of the input keys 13 of the remote controller 12. Even if any one of the input keys 13 is depressed, if the no-operation time continues after that, the DVD device 20 continues the operations in steps D-3 to D-9.

As described above, in the blinking power-saving mode in the display tube 19 of the DVD device 20, the display tube 19 is completely off in the light-off time designated by the user. Thus, the DVD device 20, which executes the blinking power-saving mode, can reduce power consumption. In executing the blinking power-saving mode, it is possible to perform setting with simple operation of depressing the input keys 13 arranged on the remote controller 12 of the DVD device 20. Thus, it is possible to prevent operators from being limited even in general homes. Moreover, during execution of the blinking power-saving mode, the display tube 19 repeats blinking on the basis of a blinking interval of a predetermined time set by the user. The DVD device 20 can automatically return to time display with original brightness when the user, who notices the blinking of the display tube 19, simply depresses any one of the input keys 13. Thus, the DVD device 20 can return to the original state even if the user does not depress the specific input key 13 such as a not-shown cancellation key of the remote controller 12 for canceling the power-saving mode to return the DVD device 20 to the original state from the power-saving mode. Anybody can return the DVD device 20 to the original state easily when he/she finds the state in which the power-saving mode is executed. The display tube 19 repeats light-off and light-on at a predetermined interval. Since the display tube 19 displays information with original brightness at the time of light-on, when the display tube 19 displays information brightly, the user can understand that what time the present time is. In addition, it is possible to solve the problem in that the user misunderstands that the power supply is off and forgets to turn off the power supply. Even if any one of the input keys 13 is depressed, it is possible to continue the operations in steps D-3 to D-9 if the no-operation time continues after that.

### Third Embodiment

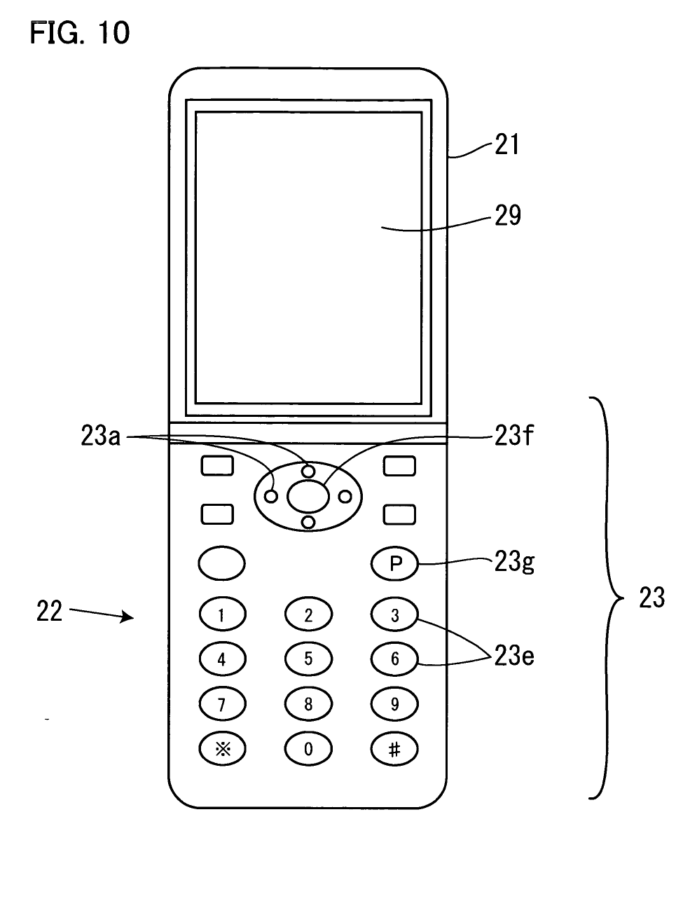

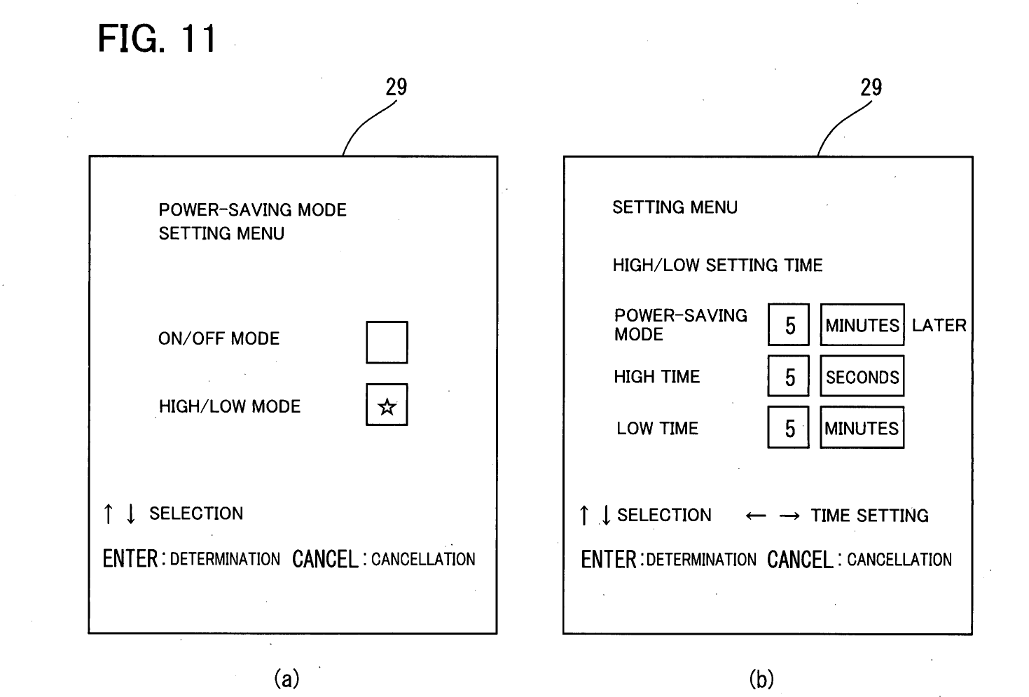

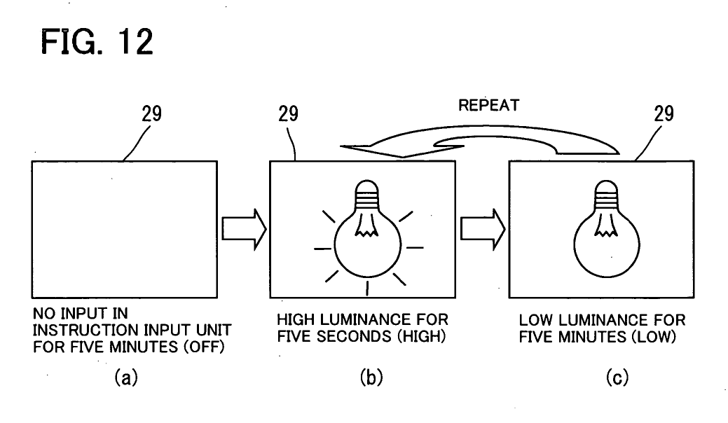

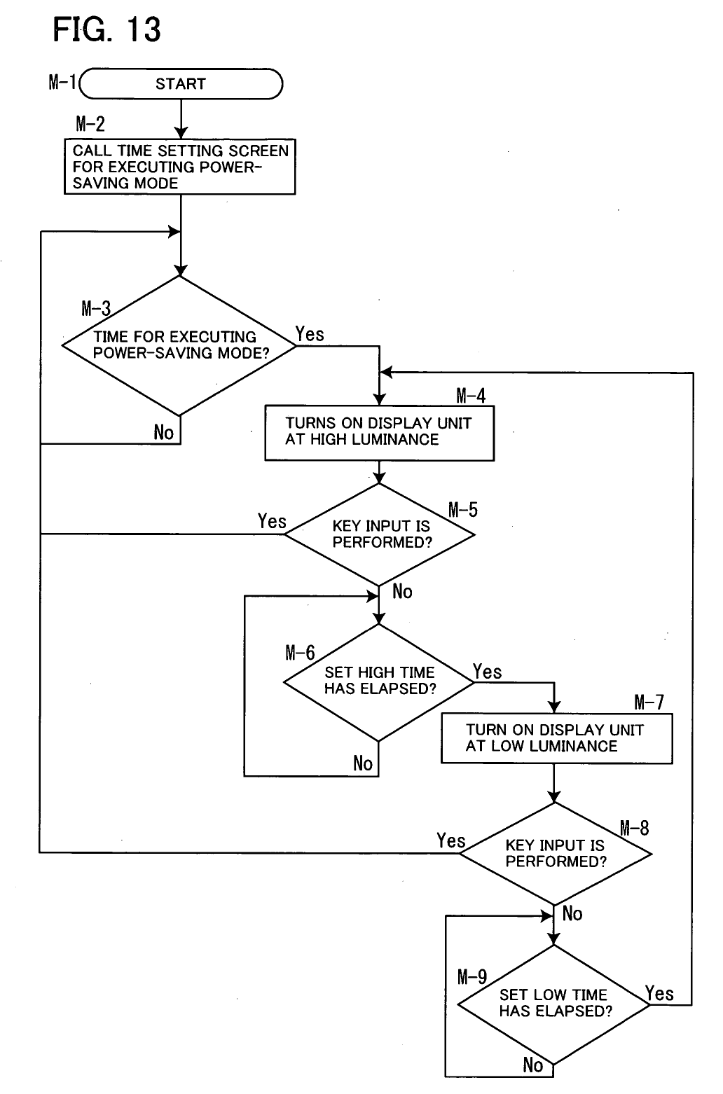

A third embodiment of the invention will be explained with reference to FIGS. 9 to 11. The third embodiment is a cellular phone that includes a display screen for the blinking power-saving mode and a luminance-changing power-saving mode, one of which a user can select and execute. In this embodiment, the luminance-changing power-saving mode will be explained. FIG. 9 is a block diagram for explaining a display control method for a display screen in the cellular phone. FIG. 10 is a diagram for explaining a setting menu screen for the luminance-changing power-saving mode selected. FIGS. 11A and 11B are diagrams for explaining a selection menu screen for the blinking power-saving mode and the luminance-changing power-saving mode and a setting menu screen for the luminance-changing power-saving mode selected. FIGS. 12A to 12C are diagrams for explaining an example of display of a display screen in the luminance-changing power-saving mode. FIG. 13 is a flowchart showing an operation flow in the luminance-changing power-saving mode.

A cellular phone 30 shown in FIG. 9 includes an operation key unit 22 that inputs an instruction according to operation of plural input keys 23, a microcomputer 21 that controls execution of a power-saving mode on the basis of the instruction inputted, and a display screen 29 that is controlled by the microcomputer 21 to execute power-saving mode display. The microcomputer 21 includes an operation instructing unit 24 that receives an instruction from the operation key unit 22 and instructs an operation, an operation control unit 25 that receives an instruction from the operation instructing unit 24 and controls an operation, a timer 26 that is controlled by the operation control unit 25 to perform timer setting, a setting holding memory 27 that is controlled by the operation control unit 25 to hold a setting for a power-saving mode, and a screen display control unit 28 that is controlled by the operation control unit 25 to control the display screen 29. The display screen 29 is controlled by the screen display control unit 28 to display information. In the cellular phone 30, in executing the power-saving mode, the timer 26 measures elapsed times for a no-operation time, which is a standby time during which neither the operation key unit 22 nor any one of the input keys 23 is operated by a user or, when the cellular phone 30 is a folding type cellular phone, a folding section of the cellular phone 30 is not opened and closed, until the power-saving mode is executed, an LOW time during which the display screen 29 displays information at low luminance, and a HIGH time during which the display screen 29 displays information at high luminance. The setting holding memory 27 holds time setting data for each of the no-operation time, the LOW time, and the HIGH time. The screen display control unit 28 controls the display screen 29 to repeat low luminance and high luminance. Consequently, when the no-operation time, during which operation of the operation key unit 22 is not performed, exceeds a predetermined time, it is possible to execute the luminance-changing power-saving mode in which the display screen 29 repeats high luminance and low luminance at a predetermined interval. In the cellular phone 30, the timer 26 measures elapsed times for a no-operation time, which is a standby time until a power-saving mode is executed, an ON time during which the display screen 29 is on, and an OFF time during which the display screen 29 is off. The setting holding memory 27 holds time setting data for each of the no-operation time, the ON time, and the OFF time. The screen display control unit 28 controls the display screen 29 to repeat light-on and light-off. Consequently, when the no-operation time, during which operation of the operation key unit 22 is not performed, exceeds a predetermined time, it is also possible to execute the blinking power-saving mode in which the display screen 29 repeats light-on and light-off at a predetermined interval. It is possible to select and set modes and times according to a selection menu displayed on the display screen 29.

A schematic arrangement of the operation key unit 22 and the display screen 29 in the cellular phone 30 will be explained with reference to FIG. 10. In FIG. 10, the operation key unit 22 is provided on a lower side of the cellular phone 30. In the operation key unit 22, the input keys 23 such as a mode selecting key 23a, a ten key 23e for inputting numerical values, an Enter key 23f for determining an input content, and a Cancel key 23g for canceling an input content are arranged. The display screen 29 is arranged on an upper side of the cellular phone 30. A user can depress any one of the input keys 23 to input an instruction.

The input keys 23 arranged in the operation key unit 22 of the cellular phone 30 are operated to select the luminance-changing power-saving mode from the blinking power-saving mode and the luminance-changing power-saving mode on the selection menu screen. FIGS. 11A to 11C are diagrams for explaining an example of display on the display screen 29 in the luminance-changing power-saving mode selected. FIG. 11A is a menu screen for selecting one of the blinking power-saving mode and the luminance-changing power-saving mode. An ON/OFF mode representing the blinking power-saving mode and a HIGH/LOW mode representing the luminance-changing power-saving mode are displayed on the display screen 29. A user depresses the mode selecting key 23a in accordance with selection of arrows in upward and downward directions, which are provided on a lower side of the display screen 29, to select the luminance-changing power-saving mode. The user depresses the Enter key 23f to determine the selection. In a setting menu in FIG. 11B appearing next, the user selects the power-saving mode with the mode selection key 23a in accordance with an input menu for HIGH/LOW setting time. After depressing the ten key 23e to enter “5”, the user selects “minute” with the mode selecting key 23a. Consequently, time until the power-saving mode is executed is displayed as “five minutes” later. The user enters the HIGH time as “5” “seconds” and enters the LOW time as “5” “minutes” and depresses the Enter key 23f to complete the setting.

The luminance-changing power-saving mode and an example of screen display in the luminance-changing power-saving mode will be explained with reference to FIG. 12. When the cellular phone 30 is not used for a call, a date and time, a radio wave reception state, battery power, and the like are displayed on a screen of the cellular phone 30. Usually, after a call, a backlight of a liquid crystal display panel is off and dim for a while and a user cannot see anything. However, in the luminance-changing power-saving mode, it is possible to repeat high-luminance display and low-luminance display at a predetermined interval when the user, who does not carry a watch, is concerned about a present time and an elapsed time because the user has an appointment, a meeting, or the like. The high-luminance display is display with brightness of the display screen 29 during a call. The low-luminance display is display with brightness that is low but allows the user to read the display screen 29. The user can arbitrarily set brightness in the low-luminance display. In this way, the luminance-changing power-saving mode in the cellular phone 30 is a function for reducing power consumed in the display screen 29 by decreasing and increasing brightness of the display screen 29 at the predetermined interval as required by the user rather than completely turning off the display screen 29. FIG. 12A shows a state in which the operation key unit 22 shown in FIG. 9 has already been operated to instruct an execution operation for the luminance-changing power-saving mode. For example, when the luminance-changing power-saving mode is set at five minutes before an appointment at 10 o'clock, the screen of the display screen 29 is dim until the time of the appointment, 10 o'clock. However, at 10 o'clock, the screen is kept on at high luminance for five seconds as shown in FIG. 12B. When five seconds elapse, the screen displays information dimly as shown in FIG. 12C. Thus, the user can easily understand that it is 10 o'clock if the user visually recognizes that the display screen 29, which has been dim, displays information at high luminance suddenly. After that, since the display screen 29 displays information dimly, the user can learn a present time at the right moment. The display screen 29 repeatedly displays information at high luminance five minutes later and displays information dimly after the five minutes elapse to display information by a unit of five minutes. Thus, the user can easily judge how long the user has been waiting. When the user has successfully met a person with whom the user has an appointment, the user operates any one of the input keys 23 in the operation key unit 22 of the cellular phone 30. When the cellular phone 30 is a folding type cellular phone, the user opens and closes a folding section of the cellular phone 30. Consequently, the display screen 29 easily returns to the light-off state completely. Thus, it is possible to minimize consumption of the battery.

An operation in the luminance-changing power-saving mode in the cellular phone 30 will be explained with reference to FIG. 13. In step M-1, the luminance-changing power-saving mode is about to be started. In step M-2, a user operates the operation key unit 22 shown in FIG. 9 to display a time setting screen for executing a power-saving mode shown in FIG. 11B on the display screen 29. If setting for executing the luminance-changing power-saving mode has not been made, the user sets the standby time, the HIGH time, and the LOW time in the luminance-changing power-saving mode on the basis of the setting menu explained with reference to FIG. 11B. Step M-3 and subsequent steps indicate a stage in which the cellular phone 30 executes an operation according to the setting conditions for the luminance-changing power-saving mode set. In step M-3, the timer 26 shown in FIG. 9 watches whether five minutes, the standby time until execution of the luminance-changing power-saving mode set in FIG. 11A, have elapsed. If it is not the time for executing the luminance-changing power-saving mode, the timer 26 judges that five minutes have not elapsed (“NO” in step M-3) and continues to watch time instep M-3. When five minutes have elapsed, the timer 26 judges that five minutes have elapsed (“YES” in step M-3) . In step M-4, the display screen 29 is kept on at high luminance for five seconds set in FIG. 11B. Thereafter, in step M-5, the cellular phone 30 checks whether the user has depressed any one of the input keys 23 of the operation key unit 22 while the display screen 29 is on at high luminance. When the cellular phone 30 is a folding type cellular phone, the cellular phone 30 checks whether a folding section is opened and closed. When any one of the input keys 23 is depressed or when the folding section is opened and closed, the cellular phone 30 judged that any one of the input keys 23 is depressed (“YES” in step M-5) and returns to step M-3. The timer 26 shown in FIG. 9 starts measurement of time until the luminance-changing power-saving mode is executed in the no-operation time of the operation key unit 22. At this point, if none of the input keys 23 is depressed or the folding section is not opened and closed, the timer 26 judges that five minutes have not elapsed (“NO” in step M-3).

An operation for detecting depression of any one of the input keys 23 or opening and closing of the folding section to cancel the luminance-changing power-saving mode will be explained. When the user depresses any one of the input keys 23 or opens and closes the folding section, the operation instructing unit 24 informs the operation control unit 25 that any one of the input keys 23 is depressed or the folding section is opened and closed. If the depression of the input key 23 is an instruction for making a call, the operation control unit 25 informs a not-shown call control unit of the cellular phone 30 of a content of the instruction. In addition, the operation control unit 25 controls the screen display control unit 28 and the timer 26 to cancel the luminance-changing power-saving mode. According to the cancellation of the luminance-changing power-saving mode, the timer 26 starts measurement of time until the luminance-changing power-saving mode is executed again.

In the case of “NO” in step M-5, the display screen 29 is still on at high luminance at the HIGH time. In step M-6, the timer 26 continues to measure the HIGH time, which is the high-luminance light-on time. When the HIGH time has not elapsed (“NO” in step M-6), the timer 26 repeats the measurement until five minutes elapse. When five minutes have elapsed and the timer 26 judges in step M-6 that the HIGH time has elapsed (“YES” in step M-6), in step M-7, the cellular phone 30 changes the display screen 29 to LOW and keeps the display screen 29 on for five seconds at low luminance. After the display screen 29 is turned on at low luminance, in step M-8, the cellular phone 30 checks whether the user has depressed any one of the input keys 23 of the operation key unit 22 or opened and closed the folding section while the display screen 29 is on at low luminance. When any one of the input keys 23 is depressed, the cellular phone 30 judges that any one of the input keys 23 is depressed (“YES” in step M-8) and returns to M-3. The timer 26 shown in FIG. 9 starts measurement of time until the luminance-changing power-saving mode is executed in the no-operation time of the operation key unit 22. At this point, if none of the input keys 23 is depressed or the folding section is not opened and closed, the timer 26 judges that five minutes have not elapsed (“NO” in step M-3). In step M-9, the timer 26 continues to measure the set LOW time, that is, the low-luminance light-on time, of five seconds. When the LOW time of five seconds has elapsed, the timer 26 judges that the LOW time has elapsed (“YES” in step M-9) and returns to step M-4. The display screen 29 is turned on at high luminance. After that, high-luminance light-on and low-luminance light-on of the display screen 29 is repeated continuously until the user depresses any one of the input keys 23 of the operation key unit 22 or opens and closes the folding section. Even if any one of the input keys 23 is depressed or the folding section is opened and closed, if the no-operation time continues after that, the cellular phone 30 continues the operations in steps M-3 to M-9.

As described above, when the cellular phone 30 is not used for a call, a date and time, a radio wave state, battery power, and the like are displayed on a screen of the cellular phone 30. Usually, after a call, a backlight of the display screen 29 is off and dim for a while and a user cannot see anything. However, in the luminance-changing power-saving mode, it is possible to repeat high-luminance display and low-luminance display at a predetermined interval when the user, who does not carry a watch, is concerned about a present time and an elapsed time because the user has an appointment, a meeting, or the like. The high-luminance display is display with brightness of the display screen 29 during a call. The low-luminance display is display with brightness that is low but allows the user to read the display screen 29. The user can arbitrarily set brightness in the low-luminance display. In this way, in the luminance-changing power-saving mode in the cellular phone 30, it is possible to reduce power consumed in the display screen 29 by decreasing and increasing brightness of the display screen 29 at the predetermined interval as required by the user rather than completely turning off the display screen 29. For example, when the luminance-changing power-saving mode is set at five minutes before an appointment at 10 o'clock, the screen of the display screen 29 is dim until the time of the appointment, 10 o'clock. However, at 10 o'clock, the display screen 29 is on at high luminance for five seconds. When five seconds elapse, the display screen 29 displays information dimly. Thus, the user can easily understand that it is 10 o'clock if the user visually recognizes that the display screen 29, which has been dim, displays information at high luminance suddenly. After that, since the display screen 29 displays information dimly, the user can learn a present time at the right moment. The display screen 29 repeatedly displays information at high luminance five minutes later and displays information dimly after the five minutes elapse to display information at high luminance by a unit of five minutes. Thus, the user can easily judge how long the user has been waiting. When the user has successfully met a person with whom the user has an appointment, the user operates any one of the input keys 23 in the operation key unit 22 of the cellular phone 30. When the cellular phone 30 is a folding type cellular phone, the user opens and closes a folding section of the cellular phone 30. Consequently, the display screen 29 easily returns to the light-off state completely. Thus, it is possible to minimize consumption of the battery. Even if any one of the input keys 23 is depressed or the folding section is opened and closed, if the no-operation time continues after that, the cellular phone 30 can continue the operations in steps M-3 to M-9.

As described above, when there is no operation by the input keys 3, 13, or 23 of the remote controller 2 or 12 or the electronic apparatus body, it is possible to change brightness of the display screen 9 or 29 or the display tube 19 at a predetermined interval or repeating bright display and dim display by changing brightness. In addition, it is possible to return the brightness of the display screen 9 or 29 or the display tube 19 to original brightness or dimness simply by depressing any one of the input keys 3, 13, or 23 or, in the folding type cellular phone 30, opening and closing the folding section. In the conventional techniques, when power consumption is reduced by decreasing brightness of the display unit stepwise, it is likely that, when the brightness is too low, a user considers that a power supply of an electronic apparatus is off and forgets to turn off the power supply. In the case of the cellular phone 30, a clock display is dim and hard to read when luminance of the display screen 29 is decreased. It is necessary to increase luminance of the display screen 29 by performing specific operation of the input keys 23, for example, depressing a not-shown cancellation key of the operation key unit 22 for canceling the power-saving mode, to set the display screen 29 to high luminance. However, as described above, it is possible to provide the display control function that improves the method of reducing power consumption in the conventional techniques, prevents a user from forgetting to turn off a power supply, and makes it possible to save power for operation for returning the display screen 29 to a normal state from the power-saving mode. Thus, it is possible to reduce power consumption of a plasma display panel in a large-size television, a CRT or a liquid crystal display panel in the television 10, a personal computer, and the like, a liquid crystal display panel in a subscriber telephone and the cellular phone 30, and the display tube 19 used for applications such as a VCR device and the DVD device 20. In addition, as in the embodiment of the cellular phone 30, if necessary, predetermined dimness and usual brightness at the time of a call are repeated. This allows a user to know at a glance how long the user has been waiting in the case of an appointment or the like. When a person, with whom the user has an appointment, appears, the user can turn off the backlight naturally. Even if any one of the input keys 3, 13, or 23 is depressed, after that, if the no-operation time continues, it is possible to continue the operation in steps T-3, D-3, or M-3 to T-9, D-9, or M-9.

The embodiments have been described in detail. However, the invention is not limited to the embodiments and can be modified in various ways within the range of the spirit of the invention. For example, the luminance-changing power-saving mode may be carried out on the display screen 9 such as a plasma display panel used in a large-size television 10 and the like and a liquid crystal panel of a personal computer. An arrangement of the input keys 3, 13, or 23 and a display content of the setting menu screen are not limited to the embodiments and only have to be selected appropriately. For example, the arrangement and the display content may be changed taking into account easiness of use in the remote controller 2 or 12 or the operation key unit 23.

According to the first aspect of the invention, the electronic apparatus with a display control function includes: an instruction input unit that inputs an instruction according to operation of plural input keys; an operation instructing unit that instructs an operation on the basis of the instruction inputted; an operation control unit that receives an instruction from the operation instructing unit and controls an operation; a timer that is controlled by the operation control unit to perform timer setting; a setting holding memory that is controlled by the operation control unit to hold a setting; a display control unit that is controlled by the operation control unit to control a display unit; and a display unit that is controlled by the display control unit to display information. In the electronic apparatus, the timer measures elapsed times for a no-operation time, which is standby time during which none of the input keys is operated, until a power-saving mode is executed, an OFF time during which the display unit is off, and an ON time during which the display unit is on. The setting holding memory holds time setting data for each of the no-operation time, the OFF time, and the ON time. The display control unit controls the display unit to blink. Consequently, the electronic apparatus executes, when the no-operation time, during which operation of the instruction input unit is not performed, exceeds a predetermined time, a blinking power-saving mode in which the display unit repeats light-on and light-off at a predetermined interval. Thus, when there is no operation by input keys of a remote controller or an electronic apparatus body for a predetermined time, the electronic apparatus can repeat light-off and light-on with usual brightness at a predetermined interval. Therefore, a user can visually recognize a displayed content on the display unit clearly when the display unit is on brightly and can control power consumption of the display unit when the display unit is off. In the method of reducing power consumption in the conventional technique, when power consumption is reduced by decreasing brightness of the display unit stepwise, it is likely that, when the brightness is too low, a user considers that a power supply of an electronic apparatus is off and forgets to turn off the power supply. According to the first aspect of the invention, it is possible to improve the method and obtain an electronic apparatus with a display control function for preventing a user from forgetting to turn off a power supply.

According to the second aspect of the invention, it is possible to set the no-operation time, the OFF time, and the ON time according to operation of the input keys. Thus, a user can perform time setting as the user desires according to a situation. Therefore, for example, the user can set an arbitrary no-operation time taking into account time for taking care of things to do, bedtime, and the like and set a convenient interval for light-on time and light-off time. Consequently, the electronic apparatus can prevent a problem of giving displeasure to the user by operating at time programmed in the electronic apparatus.

According to the third aspect of the invention, the electronic apparatus executes, when operation of the instruction input unit is not performed for a predetermined time, a luminance-changing power-saving mode in which low-luminance display for decreasing luminance of the display unit to predetermined luminance and high-luminance display with usual luminance are repeated at the predetermined interval. Thus, the electronic apparatus can repeat usual brightness and low brightness alternately at a predetermined interval when it is inconvenient to turn off the display unit completely. Therefore, a user can visually recognize a displayed content clearly when the content is brightly displayed periodically. When the user does not wish to display a content brightly to avoid attention, the user can visually recognize a displayed content without worry by adjusting luminance to cause the electronic apparatus to perform predetermined low-luminance display.

According to the fourth aspect of the invention, when any one of the plural input keys is depressed and when the electronic apparatus performs a specific operation during execution of the blinking power-saving mode or the luminance-changing power-saving mode, the electronic apparatus cancels the repetition operations and returns to an original state and does not execute the blinking power-saving mode or the luminance-changing power-saving mode until the time when operation of the instruction input unit is not performed even if the predetermined time elapses again. Thus, the electronic apparatus can easily returned to an original state from the power-saving mode of the invention when a user simply depresses any one of the input keys of the electronic apparatus at random and, in the case of a folding type cellular phone, performs a specific operation of opening and closing a folding section of the cellular phone. Therefore, the user does not have to perform a complicated operation, for example, depress a specific input key such as a cancellation key of a remote controller for canceling a power-saving mode. It is possible to save power consumed by operation for returning the electronic apparatus from the power-saving mode to a normal state.

What is claimed is:

1. An electronic apparatus with a display control function comprising:
an instruction input unit that inputs an instruction according to operation of plural input keys;
an operation instructing unit that instructs an operation on the basis of the instruction inputted;
an operation control unit that receives an instruction from the operation instructing unit and controls an operation;
a timer that is controlled by the operation control unit to perform timer setting;
a setting holding memory that is controlled by the operation control unit to hold a setting;
a display control unit that is controlled by the operation control unit to control a display unit; and
a display unit that is controlled by the display control unit to display information, wherein the timer measures elapsed times for a no-operation time, which is a standby time during which none of the input keys is operated, until a power-saving mode is executed, an OFF time during which the display unit is off, and an ON time during which the display unit is on,
the setting holding memory holds time setting data for each of the no-operation time, the OFF time, and the ON time,
the display control unit controls the display unit to blink, and
the electronic apparatus executes, when the no-operation time, during which operation of the instruction input unit is not performed, exceeds a predetermined time, a blinking power-saving mode in which the display unit repeats light-on and light-off at a predetermined interval.

2. The electronic apparatus with a display control function according to claim 1, wherein it is possible to set the no-operation time, the OFF time, and the ON time according to operation of the input keys.

3. The electronic apparatus with a display control function according to claim 2, wherein the electronic apparatus executes, when operation of the instruction input unit is not performed for a predetermined time, a luminance-changing power-saving mode in which low-luminance display for decreasing luminance of the display unit to predetermined luminance and high-luminance display with usual luminance are repeated at the predetermined interval.

4. The electronic apparatus with a display control function according to claim 2, wherein, when any one of the plural input keys is depressed and when the electronic apparatus performs a specific operation during execution of the blinking power-saving mode or the luminance-changing power-saving mode, the electronic apparatus cancels the repetition operations and returns to an original state and does not execute the blinking power-saving mode or the luminance-changing power-saving mode until the time when operation of the instruction input unit is not performed even if the predetermined time elapses again.

5. The electronic apparatus with a display control function according to claim 3, wherein, when any one of the plural input keys is depressed and when the electronic apparatus performs a specific operation during execution of the blinking power-saving mode or the luminance-changing power-saving mode, the electronic apparatus cancels the repetition operations and returns to an original state and does not execute the blinking power-saving mode or the luminance-changing power-saving mode until the time when operation of the instruction input unit is not performed even if the predetermined time elapses again.
